(19) United States
(12) Patent Application Publication
(10) Pub. No.: US 2021/0034580 A1
(43) Pub. Date: Feb. 4, 2021

(54) METHOD, APPARATUS AND COMPUTER PROGRAM PRODUCT FOR MAINTAINING METADATA

(71) Applicant: EMC IP Holding Company LLC, Hopkinton, MA (US)

(72) Inventors: Guoyu Hu, Beijing (CN); Chen Gong, Beijing (CN); Hao Fang, Beijing (CN); Ming Zhang, Beijing (CN); Huan Chen, Beijing (CN)

(21) Appl. No.: 16/876,451

(22) Filed: May 18, 2020

(30) Foreign Application Priority Data
Jul. 31, 2019 (CN) 201910700539.0

(51) Int. Cl. G06F 16/18; G06F 16/182; G06F 16/16; G06F 16/17; G06F 16/176

(52) U.S. Cl. CPC G06F 16/1865; G06F 16/1827; G06F 16/1774; G06F 16/1734; G06F 16/164

(57) ABSTRACT

Techniques for metadata maintenance involve: obtaining a transaction that is currently pending, the transaction being associated with a modification of a metadata block, the metadata block containing entries, the transaction including sub-transactions which indicate modifications; ordering the sub-transactions depending on record writing type, e.g., permission-required control type or a permission-free control type; in response to acquiring a permission, generating, in a first storage area, a respective metadata modification record preferentially for each sub-transaction of the permission-required control type, wherein the respective metadata modification record describes a modification of at least one entry of the metadata block that is indicated by the sub-transaction; and in response to generating the metadata modification records for all the sub-transactions of the permission-required control type, releasing the permission such that a further transaction will have an opportunity to acquire the permission.

### CROSS-REFERENCE TO RELATED APPLICATION

This application claims priority to Chinese Patent Application No. CN201910700539.0, on file at the China National Intellectual Property Administration (CNIPA), having a filing date of Jul. 31, 2019, and having “METHOD, APPARATUS AND COMPUTER PROGRAM PRODUCT FOR MAINTAINING METADATA” as a title, the contents and teachings of which are herein incorporated by reference in their entirety.

### FIELD

Embodiments of the present disclosure relate to the field of data storage, and more specifically to a method, electronic device and computer program product for transaction-based metadata maintenance.

### BACKGROUND

In modern data storage systems, data is classified into actual data and metadata (i.e., metadata block). The actual data corresponds to real data (files), such as documents, audio, video, pictures and the like stored by a user. The metadata block refers to data used to describe characteristics of the actual data, such as access permission, the owner(s) of the actual data, distribution information of the actual data blocks, and so on. Take a file system based on a modern storage system as an example, in order to manage storage objects efficiently, the file system usually creates an inode for storing information related to a storage object (for example, a file) of the file system. The file system may create an associated inode (i.e., metadata block) for each stored file. An inode as metadata block is represented as a data structure in which data of a file is not directly stored, but specific information related to the file is stored. When a user needs to operate a file through the data storage system, he may obtain its metadata block firstly, and then locate a position of the file and obtain the content or related attributes of the file. Therefore, it is desirable to provide an efficient and reliable mechanism for implementing metadata maintenance.

### SUMMARY

Embodiments of the present disclosure provide a solution for metadata maintenance.

In a first aspect of the present disclosure, there is provided a method for metadata maintenance. The method includes: obtaining a transaction that is currently pending, the transaction being associated with a modification of a metadata block, the metadata block containing at least one entry, the transaction including at least one sub-transaction, each of which indicates a modification of at least one entry of the metadata block; ordering the at least one sub-transaction of the transaction depending upon a record writing type of the at least one sub-transaction, the record writing type of the at least one sub-transaction being one of a permission-required control type and a permission-free control type; in response to acquiring a permission, generating, in a first storage area, a respective metadata modification record preferentially for each sub-transaction of the permission-required control type, wherein the respective metadata modification record describes a modification of at least one entry of the metadata block that is indicated by the sub-transaction; and in response to generating the metadata modification records for all the sub-transactions of the permission-required control type, releasing the permission such that a further transaction will have an opportunity to acquire the permission.

In a second aspect of the present disclosure, there is provided an electronic device for metadata maintenance. The electronic device includes a processor and a memory coupled to the processor and having instructions stored thereon, the instructions, when executed by the processor, causing the electronic device to perform acts. The acts include obtaining a transaction that is currently pending, the transaction being associated with a modification of a metadata block, the metadata block containing at least one entry, the transaction including at least one sub-transaction, each of which indicates a modification of at least one entry of the metadata block; ordering the at least one sub-transaction of the transaction depending upon a record writing type of the at least one sub-transaction, the record writing type of the at least one sub-transaction being one of a permission-required control type and a permission-free control type; in response to acquiring a permission, generating, in a first storage area, a respective metadata modification record preferentially for each sub-transaction of the permission-required control type, wherein the respective metadata modification record describes a modification of at least one entry of the metadata block that is indicated by the sub-transaction; and in response to generating the metadata modification records for all the sub-transactions of the permission-required control type, releasing the permission such that a further transaction will have an opportunity to acquire the permission.

In a third aspect of the present disclosure, there is provided a computer program product. The computer program product is tangibly stored on a computer-readable medium and includes machine-executable instructions, the machine executable instructions, when executed, causing a machine to perform the method according to the first aspect.

In a fourth aspect of the present disclosure, there is provided a computer-readable medium having computer-readable instructions stored thereon. The computer-readable instructions, when executed, cause a device to perform the method according to the first aspect.

The Summary is to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

The above and other objectives, advantages and features of the present disclosure will become more apparent through the detailed description of example embodiments of the present disclosure with reference to the accompanying drawings, where the same reference symbols generally refer to the like elements in the example embodiments of the present disclosure.

FIG. 1 illustrates a schematic diagram of a data storage system in which embodiments of the present disclosure may be implemented;

FIG. 2 illustrates a flow chart of a process of metadata maintenance according to an embodiment of the present disclosure;

FIG. 3 illustrates an example structure of a transaction before ordering according to an embodiment of the present disclosure;

FIG. 4 illustrates an example structure of a transaction after ordering according to an embodiment of the present disclosure;

FIG. 5 illustrates a block diagram of an example device that may be used for implementing embodiments of the present disclosure.

### DETAILED DESCRIPTION OF EMBODIMENTS

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

Principles of the present disclosure will now be described with reference to several example embodiments illustrated in the drawings. Although some preferred embodiments of the present disclosure are shown in the drawings, it would be appreciated that description of those embodiments is merely for the purpose of enabling those skilled in the art to better understand and further implement the present disclosure and is not intended for limiting the scope disclosed herein in any manner.

As used herein, the term “include” and its variants are to be read as open-ended terms that mean “include, but is not limited to.” The term “or” is to be read as “and/or” unless explicitly being defined otherwise. The term “based on” is to be read as “based at least in part on.” The terms “one example embodiment” and “an embodiment” are to be read as “at least one example embodiment.” The term “another embodiment” is to be read as “at least one further embodiment.” The terms “first” and “second” may represent different or the same objects. Other definitions, either explicit or implicit, may be included below.

The term “transaction” as used herein refers to a unit for executing operation in a system, and transaction is the minimum execution unit executed by the system. Transaction, as a whole, is in a state of successful execution or failed execution during execution. In a data storage system such as a file system, the transaction is usually associated with operations of data in the system (e.g., creation, modification, deletion, copying, cutting and pasting of files in the file system).

The term “sub-transaction” as used herein refers to an operation indication during the execution of a “transaction”. A transaction may include at least one sub-transaction.

As discussed above, the maintenance of metadata is very important in data storage systems. In a traditional solution, when the metadata block changes, the data storage system needs to generate a modification record of the metadata block in the form of a log while modifying the metadata block, thereby enabling a rollback operation and improving the reliability of the data storage system. Furthermore, in order to improve the efficiency of the modification of metadata block operation, in the conventional solution, the log for the modification of metadata block operation is recorded in a memory/cache firstly and then is written/flushed to a magnetic disk by batch processing. Furthermore, in order to improve the efficiency of the data storage system at runtime, there are usually mirrors of some metadata block in the memory/cache, and the modification operation of the metadata block in the data storage system is not directly modifying the metadata block in the magnetic disk, but modifying the mirror of the metadata block in the memory/cache. The modified metadata block is recorded into a dirty buffer area, the data in the dirty buffer area is finally written to the magnetic disk via a background program to enable the modification of metadata block.

Modification of metadata block is a time-sensitive operation. Therefore, when the rollback operation is performed according to the modification log of the metadata block, the latest modification of metadata block operation should be able to rewrite the previous modification of metadata block operation. In addition, the dirty data stored in the dirty buffer area to be written/flushed into the magnetic disk should correspond to the latest modification of metadata block operation. Therefore, the metadata maintenance must ensure:
When performing the operation of recording the log of modification of metadata block, a later-recorded log should record the updated modification operation compared with a previous log.
The dirty data stored in the dirty buffer area should correspond to the latest modification of metadata block, or when the dirty buffer area runs in a first-in-first-out (FIFO) mechanism, multiple copies of the metadata block are sequentially written/flushed to the dirty buffer area in a sequence of generation time.

The Inventor has noted that in order to ensure timing sequence requirements during the modification of metadata block process, one possible implementation solution is to control the recording process of the metadata modification log through a global log lock. For example, an event 1 that triggers modification of metadata block occurs at a first time point and a transaction A is used to describe the modification of metadata block operation associated with the event 1; The transaction A may include sub-transactions (a1, a2, a3, a4), wherein the metadata block of the sub-transaction a1 has a mirror in the memory/cache; another event 2 that triggers the modification of metadata block occurs at a subsequent second time point, and a transaction B is used to describe the modification of metadata block operation associated with the event 2. The transaction B may include sub-transactions (b1, b2, b3, b4), wherein the metadata block corresponding to sub-transaction b2 has a mirror in the memory/cache. When a computing device performs the operation of recording the metadata modification log, the transaction A obtains the global lock firstly, generates metadata modification records for the sub-transactions a1, a2, a3, and a4 sequentially, and inserts the a1 into a post-processing list (the post-processing list is used for the modification of metadata block mirror in the memory/cache). The transaction A releases the global lock after looping all the sub-transaction in the transaction A. Subsequently, the transaction B obtains the global lock, sequentially generates metadata modification records for sub-transactions b1, b2, b3, b4, and inserts b2 into a post-processing list (located behind sub-transaction a1). The transaction B releases the global lock after looping all the sub-transaction in the transaction B. The inventor has noticed that although the timing sequence requirements during the metadata maintenance process can be guaranteed in this way, when there are multiple transactions that are currently pending and each transactions that is currently pending includes a large number of sub-transactions, the modification of metadata block process will takes a long time and the execution performance of the entire data storage system is very low.

The inventor has also noticed that the most time-consuming operation in the entire process of performing modification of metadata block is the operation of generating the metadata modification log. Therefore, how to improve the operation of generating the metadata modification log is a key to improve the metadata maintenance process of the data storage system.

The inventor further notes that the purpose of ensuring timing sequence is to avoid conflicts of processing between transactions. However, such transaction conflicts of processing only exist between different transactions. For example, both transaction A and transaction B need to perform modification operations on the same metadata block. There are many mechanisms used for avoiding transaction processing conflicts running in the data storage systems, and these mechanisms are repetitive to a certain degree. For example, for a sub-transaction with a particular type, the data storage system has configured a control lock for the sub-transaction (such as a read-write lock of file object, an access lock of indirect block, etc.). Therefore, when generating the metadata modification logs for sub-transactions, the global lock is not necessary for all the sub-transactions. For the sub-transactions that have guaranteed timing sequence requirements through other conflict avoidance mechanisms, the global lock for the operation of controlling the generation of the metadata modification logs becomes a redundant operation.

Furthermore, the inventor further notes that since the transaction is triggered by an event for one modification of metadata block, the modifications of the metadata block described by a plurality of sub-transactions within the same transaction are different from one another, which enables the conflicts between the plurality of sub-transactions within the same sub-transaction do not exist. This feature of sub-transactions allows the computing devices to re-order sub-transactions in the transaction so that the sub-transactions can be executed in the ordered order.

An improved solution for metadata maintenance is presented in accordance with an implementation of the present disclosure. According to the solution, when the operation of metadata maintenance is performed, particularly when the metadata modification records are generated, it is possible to enable the plurality of transactions to record the metadata modification records in parallel at least in part. In this way, the time for generating the metadata modification record is shortened, and the performance of the data storage system is improved. Specifically, the computing device orders the sub-transactions in the current pending transaction according to record writing types corresponding to the sub-transactions; when acquiring the permission, preferentially generates a metadata modification record for each sub-transaction corresponding to a permission-required control type; and releases the permission after generating the metadata modification records for all the sub-transaction corresponding to the permission-required control types. In this way, the operation of generating the metadata modification records for transactions is no longer an absolute serial operation. By fully utilizing other already-existing timing sequence guarantee mechanisms in the data storage system, the time for generating the metadata modification records is shorten while the timing sequence requirements of modification of metadata block is meet. Especially, when there are pluralities of transactions that are currently pending and each transaction contains a larger number of sub-transactions, the present disclosure may substantially improve the operational performance of the data storage system.

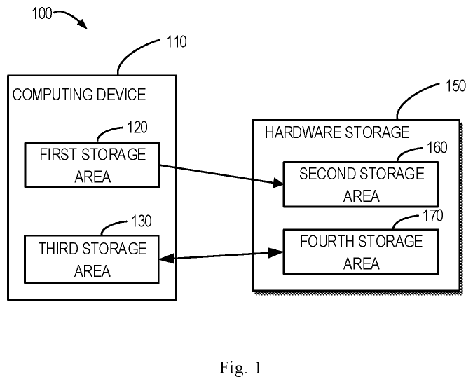

FIG. 1 illustrates a schematic diagram of a data storage system in which embodiments of the present disclosure may be implemented. The example data storage system 100 includes a computing device 110 and a hardware storage 150.

The computing device 110 acts as a core processing device of data storage system 100, and is used to perform various logical operations in data storage system 100. The computing device 110 includes a first storage area 120 and a third storage area 130 for storing the metadata modification records of and mirrors of the metadata block in the computing device 110, respectively. The first storage area 120 and the third storage area 130 may be a memory of the computing device 100 or other memory (such as a cache) that may be quickly accessed such that quick access (e.g., read, write, etc.) to the stored metadata modification records and metadata block mirror is supported. The hardware storage 150 includes a second storage area 160 and a fourth storage area 170 for storing metadata modification records and actual metadata block, respectively. The hardware storage 150 may be any type of physical device capable of providing a data storage space. Some examples of the hardware storage 150 include, but are not limited to, Solid State Drives (SSDs), Hard Disk Drives (HDDs), Serial Advanced Technology Attachment (SATA) disks, Serial Attached (SA) disks, Small Computer System Interface (SCSI) disks, SAS disks, and the like. The disk capacity of the first storage area 120 may be any size.

It should be appreciated that although FIG. 1 illustrates a specific number of computing devices 110 and hardware storages 150, the computing device 110 includes a specific number of first storage areas 120 and third storage areas 130 and the hardware storage 150 includes a specific number of second storage areas 160 and fourth storage areas 170, the number of computing devices, hardware storage, first storage areas, second storage areas, third storage areas and fourth storage areas may vary in some other example embodiments, and the scope of the present disclosure is not limited in this respect. Further, it should also be appreciated that the arrangement between the computing device 110 and hardware storage 150 is also not limited to the specific example shown in FIG. 1. In other example embodiments, the hardware storage 150 may be embedded in the computing device 110, or the hardware storage 150 may be a remote storage device, a cloud storage device or the like, and the scope of the present disclosure is not limited in this respect. In addition, it should also be appreciated that the connection relationship between the computing device 110 and the hardware storage 150 may also be in various forms, such as wired, wireless, or the Internet, and the scope of the present disclosure is not limited in this respect.

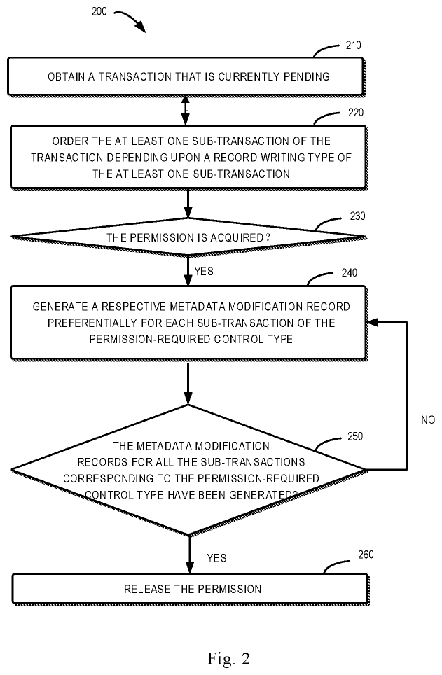

A process for transaction-based metadata maintenance will be described in more detail with reference to FIG. 2 through FIG. 4.

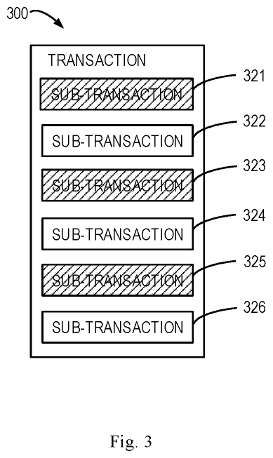

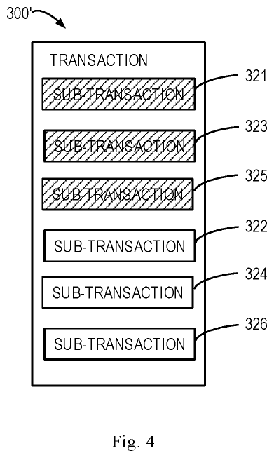

FIG. 2 illustrates a flow chart of a process 200 of metadata maintenance according to some embodiments of the present disclosure. FIG. 3 illustrates an example structure of a transaction 300 before ordering according to some embodiments of the present disclosure. FIG. 4 illustrates an example structure of a transaction 300′ after ordering according to some embodiments of the present disclosure. The process 200 may be implemented by the computing device 110 of FIG. 1. For ease of discussion, the process 200 will be described with reference to FIGS. 1 through 4.

At block 210, the computing device 110 obtains a current transaction 300 that is currently pending, and the transaction 300 is associated with a modification of metadata block. The transaction 300 may be used to describe modification operation of one metadata block. Take a file system as an example, there are many operations that trigger modification of metadata block, such as creating/modifying/copying/cutting/pasting/deleting one or more file objects, creating/modifying/copying/cutting/paste/deleting a folder including a plurality of files, and so on. These operations may cause modification of multiple metadata blocks. The metadata block as the data describing the actual data has a certain structure. More specifically, each metadata block may include at least one entry.

Referring to FIG. 3, the transaction 300 for describing modification of one metadata block operation includes six sub-transactions, namely, sub-transactions 321 through 326. For example, in a non-limiting example embodiment of the present disclosure, the computing device 110 executes an operation of deleting a folder including file 1 and file 2, and this operation requires modifying an entry a1 of the metadata block A, an entry b1 of the metadata block B, an entry cl of the metadata block C, an entry d1 of the metadata block D, an entry e1 of the metadata block E, and an entry f1 of the metadata block F. Each of sub-transactions 321, 322, 323, 324, 325 and 326 in the transaction 300 may indicate modification of the at least one entry of the metadata block. In connection with the specific example embodiment described above, the sub-transaction 321 may describe the modification of entry a1 of metadata block A, the sub-transaction 322 may describe the modification of entry b1 of metadata block B, the sub-transaction 323 may describe the modification of entry c1 of metadata block C, the sub-transaction 324 may describe the modification of the entry d1 of the metadata block D, the sub-transaction 325 may describe the modification of the entry e1 of the metadata block E, and the sub-transaction 326 may describe the modification of the entry f1 of the metadata block F.

It should be appreciated that the above-described operation of deleting a folder described in the present disclosure are merely by way of example and should not be construed as limitation for the operation of triggering the modification of metadata block. The transaction 300 may be used to describe any operations related to modification of metadata block in the data storage system. It should also be appreciated that although the transaction 300 illustrated in FIG. 3 includes six sub-transactions 321 through 326, and the six sub-transactions indicate the modification of different entries of metadata block A through F, respectively, the number of the sub-transactions and the described content may vary according to different modification of metadata block associated with the transaction 300 in some other embodiments, and the present disclosure does not limit this.

At block 220, the computing device 110 orders sub-transactions 321 through 326 in the transaction 300 based on record writing types corresponding to the sub-transactions 321 through 326.

According to some example embodiments of the present disclosure, the record writing types corresponding to the sub-transactions 321 to 326 include: a permission-required control type and a permission-free control type. According to some example embodiments of the present disclosure, the permission may be a global lock for controlling the operation of generating the metadata modification record, and the transaction may perform an operation of generating the metadata modification record in an exclusive manner after obtaining the global lock. Alternatively, according to further example embodiments of the present disclosure, the permission may be implemented in a manner such as a token. Referring back to FIG. 3, the sub-transactions 321, 323 and 325 are identified as the permission-required control type, and the sub-transactions 322, 324 and 326 are identified as the permission-free control type. FIG. 4 shows an example structure of a transaction 300′ after the transaction 300 is ordered. As shown in FIG. 4, the sub-transactions 321, 323 and 325 with the permission-required control type may be ordered before the sub-transactions 322, 324 and 326 with the permission-free control type.

According to some example embodiments of the present disclosure, before performing a ordering operation for the sub-transactions 321 through 326, an operation of identifying the record writing type of the sub-transactions 321 through 326 is further included. As previously analyzed, various timing sequence guarantee mechanisms have already existed in the data storage system to avoid conflicts in modification of metadata block operations. It is already known to the data storage system how to implement the modification of metadata block indicated by the sub-transaction, so that a pre-configured manner may be employed to configure the record writing types corresponding to the sub-transactions. For example, a sub-transaction indicating modification of the inode is configured as the permission-free control type. Such correspondence relationships may be stored in a storage device accessible by the computing device 110 in various manners, such as a matrix, a list or the like. The computing device 110 identifies the sub-transactions 321 through 326 according to the pre-configured correspondence relationships.

According to some example embodiments of the present disclosure, upon the operation of identifying a sub-transaction type, the computing device 110 simultaneously determines whether metadata block corresponding to the sub-transaction has a metadata block mirror in the memory/cache. In case that the metadata block corresponding to the sub-transaction has a metadata block mirror in the memory/cache, the operation of modifying at least one entry of the metadata block as indicated by the sub-transaction is inserted into a post-processing list. The post-processing list is used to execute the modification of the mirror of the metadata block in the memory/cache. For example, referring to FIG. 1 and FIG. 3, upon identifying the record writing type of the sub-transaction 321, the computing device 110 simultaneously determines whether the metadata block corresponding to the sub-transaction 321 has a mirror in the third storage area 130. If the determination result is yes, the operation of modifying at least one entry of the metadata block as indicated by the sub-transaction 321 is inserted into the post-processing list. The third storage area 130 may be a memory/cache of the computing device 110.

At block 230, the computing device 110 determines whether the permission is acquired. Since the modification operations of metadata block described by the transaction are time-sensitive, the different transactions can acquire the permission sequentially in order of occurrence sequence of the modification of metadata block associated with the transactions.

According to some example embodiments of the present disclosure, prior to block 230, the computing device 110 may assign transaction identification for the transaction 300, and the transaction identification indicates a chronological order between the occurrence of the modification of the metadata block associated with the transaction and the occurrence of the modification of the metadata block associated with other transactions. Specifically, subsequent transactions have transaction identification with a larger number. According to some example embodiments of the present disclosure, the transactions 300 sequentially obtain the permission according to the assigned transaction identification.

If the transaction 300 does not acquire the permission (a “NO” branch is not shown in FIG. 2), the transaction 300 will not be executed. If the transaction 300 obtains the permission, then processing flow proceeds to block 240.

At block 240, after the current transaction 300 obtains the permission, the computing device 110 preferentially generates a metadata modification record in the first storage area 120 for each sub-transaction corresponding to the permission-required control type. Each metadata modification record describes the modification of the at least one entry of the metadata block indicated by the sub-transaction. In one implementation, the computing device 110 sequentially loops the sub-transactions in the transaction 300′. Referring to FIG. 4, the computing device 110 sequentially generates the metadata modification records indicated by the sub-transactions 321, 323 and the sub-transactions 325 in the first storage region 120. According to some example embodiments of the present disclosure, the first storage area 120 is a high speed storage space such as a memory or cache area which is located in the computing device 110 and quickly accessible by the computing device 110. In this way, the metadata modification record may be quickly recorded on the computing device 110. According to some example embodiments of the present disclosure, the first storage area 120 is a storage area of a type that contents in the storage area are not lost upon power off

At block 250, the computing device 110 determines whether metadata modification records have already been generated for all the sub-transactions with the permission-required control type. When the result of determination at block 250 is “YES”, the computing device 110, at block 260, releases the permission so that other transactions will have the opportunity to acquire the permission. If the result of determination at block 250 is “NO”, the flow returns to block 240 to continue to generate metadata modification records in the first storage area 120 for the sub-transactions for which the metadata modification records have not yet been generated.

Further referring to FIG. 4, in this specific example, the computing device 110 determines whether metadata modification records have already been generated for sub-transactions 321, 323 and 325. According to some example embodiments of the present disclosure, when the computing device 110 determines that the type of the sub-transaction that is currently pending is the permission-free control type, it determines that metadata modification records have already been generated for all the sub-transactions with the permission-required control type. Further referring to the specific example embodiment of the present disclosure illustrated in FIG. 4, when the computing device 110 detects that the current sub-transaction to be processed is sub-transaction 322, the computing device 110 determines that metadata modification records have already been generated for all the sub-transactions with the permission-required control type, and then releases the permission. The released permission may be acquired by other transactions.

In this way, the duration in which the computing device 110 occupies the permission is shortened. That is, after all the sub-transactions with the permission-required control type in a transaction have been executed, the permission may be released so that other transactions will have an opportunity to acquire the permission. Thus, metadata modification records may be generated in a parallel manner among a plurality of transactions. Therefore, the time for generating the metadata modification records is shorten and the performance of the data storage system is improved.

According to some example embodiments of the present disclosure, the computing device 110 also copies the metadata modification records stored on the first storage area 120 to the second storage area 160 which is a persistent storage area. Referring to FIG. 1, the second storage area 160 may be located on the hardware storage 150. According to some example embodiments of the present disclosure, there is a mapping relationship between the first storage area 120 and the second storage area 160. More specifically, after the computing device allocates a storage space in the first storage area 120, a corresponding storage area is retained correspondingly in the second storage area 160. In this way, it may be ensured that the metadata modification records stored in the first storage area 120 may be subsequently written/flushed into the second storage area 160. In this way, it is possible to ensure reliable storage of the metadata modification records while implementing quick generation of the metadata modification records.

As discussed above, when the metadata block corresponding to the sub-transaction has a metadata block mirror in the memory/cache, the operation of modifying at least one entry of the metadata block as indicated by the sub-transaction is inserted into the post-processing list. Therefore, according to some example embodiments of the present disclosure, after the operations associated with the metadata modification records (e.g., generating metadata modification records, and writing/flushing the metadata modification records to the magnetic disk) are completed, an operation of modifying the metadata block mirror stored in the memory/cache according to the generated post-processing list is executed.

The computing device 110 finds the mirror of the metadata block stored in the memory/cache (e.g., the third storage device 130) according to the records in the post-processing list, modifies the metadata block mirror according to the post-processing list and inserts the amended metadata block into a dirty buffer area. A background program periodically writes/flushes the data in the dirty buffer area to the magnetic disk (e.g., the fourth storage area 170 shown in FIG. 1). In this way, the modification of the actual data of the metadata block is implemented. Upon modifying the metadata block, modifying the metadata block mirror data instead of directly modifying the actual metadata block in the disk enables quick modification of metadata block, and the operation of writing/flushing the modified metadata block to the magnetic disk ensures the reliability of storing the metadata block.

Since the process of generating the post-processing list and the process of identifying the record writing types of the sub-transactions are performed synchronously, the modification of metadata block operation recorded by the post-processing list also satisfies the timing sequence requirement. In this way, the present disclosure enables both the operation of modifying the metadata block mirror of the memory/cache (e.g., the third storage device 130) and the operation of writing/flushing the dirty data into the dirty buffer area to satisfy the timing sequence requirement.

According to the metadata maintenance process of the present disclosure, the permission is used and released reasonably according to the different types of sub-transactions. Therefore, the execution performance of the data storage system is improved, while the timing sequence requirement during modification of metadata block is also satisfied.

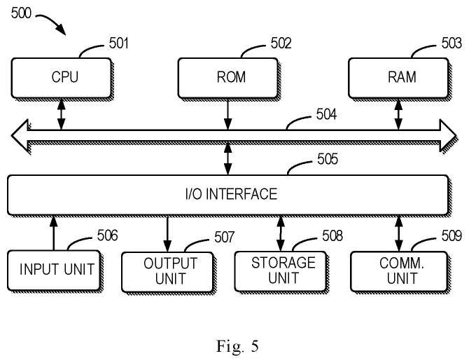

FIG. 5 illustrates a schematic block diagram of an example device 500 for implementing embodiments of the present disclosure. The device 500 may be used for implementing the process 200 of FIG. 2. As shown in the figure, the device 500 includes a central process unit (CPU) 501, which may execute various suitable actions and processing based on the computer program instructions stored in the read-only memory (ROM) 502 or computer program instructions loaded in the random-access memory (RAM) 503 from a storage unit 508. The RAM 503 may also store all kinds of programs and data required by the operations of the device 500. CPU 501, ROM 502 and RAM 503 are connected to each other via a bus 504. The input/output (I/O) interface 505 is also connected to the bus 504.

A plurality of components in the device 500 is connected to the I/O interface 505, including: an input unit 506, such as keyboard, mouse and the like; an output unit 507, e.g., various kinds of display and loudspeakers etc.; a storage unit 508, such as disk and optical disk etc.; and a communication unit 509, such as network card, modem, wireless transceiver and the like. The communication unit 509 allows the device 500 to exchange information/data with other devices via the computer network, such as Internet, and/or various telecommunication networks.

The above described each method and process, such as the process 300, may also be performed by the processing unit 501. In some embodiments, the process 300 may be implemented as a computer software program or a computer program product tangibly included in the machine-readable medium, e.g., storage unit 508. In some embodiments, the computer program may be partially or fully loaded and/or mounted to the device 500 via ROM 502 and/or communication unit 509. When the computer program is loaded to RAM 503 and executed by the CPU 501, one or more actions of the above described process 200 may be implemented. Alternatively, CPU 501 may be configured via any other suitable manners (e.g., by means of firmware) to execute the process 200 in other embodiments.

Those skilled in the art would understand that various steps of the method of the disclosure above may be implemented via a general purpose computing device, which may be integrated on a single computing device or distributed over a network composed of a plurality of computing devices. Optionally, they may be implemented using program code executable by the computing device, such that they may be stored in a storage device and executed by the computing device; or they may be made into respective integrated circuit modules or a plurality of modules or steps therein may be made into a single integrated circuit module for implementation. In this way, the present disclosure is not limited to any specific combination of hardware and software.

It would be appreciated that although several means or sub-means (e.g., specialized circuitry) of the electronic device have been mentioned in detailed description above, such partition is only example but not limitation. Actually, according to the embodiments of the present disclosure, features and functions of two or more electronic devices described above may be instantiated in one apparatus. In turn, features and functions of one electronic device described above may be further partitioned to be instantiated by various electronic devices.

What have been mentioned above are only some optional embodiments of the present disclosure and are not limiting the present disclosure. For those skilled in the art, the present disclosure may have various alternations and changes. Any modifications, equivalents and improvements made within the spirits and principles of the present disclosure should be included within the scope of the present disclosure.

I/we claim:

1. A method for transaction-based metadata maintenance, comprising:
obtaining a transaction that is currently pending, the transaction being associated with a modification of a metadata block, the metadata block containing at least one entry, the transaction comprising at least one sub-transaction, each of which indicates a modification of at least one entry of the metadata block;
ordering the at least one sub-transaction of the transaction depending upon a record writing type of the at least one sub-transaction, the record writing type of the at least one sub-transaction being one of a permission-required control type and a permission-free control type;
in response to acquiring a permission, generating, in a first storage area, a respective metadata modification record preferentially for each sub-transaction of the permission-required control type, wherein the respective metadata modification record describes a modification of at least one entry of the metadata block that is indicated by the sub-transaction; and
in response to generating the metadata modification records for all the sub-transactions of the permission-required control type, releasing the permission such that a further transaction will have an opportunity to acquire the permission.

2. The method according to claim 1, further comprising:
copying the at least one metadata modification record generated in the first storage area into a second storage area, the second storage area being a persistent storage area.

3. The method according to claim 2, further comprising:
allocating the first storage area for the transaction, the first storage area having a mapping relationship with the second storage area.

4. The method according to claim 1, further comprising:
assigning transaction identification for the transaction, the transaction identification indicating a chronological order of occurrence of the modification of the metadata block associated with the transaction and occurrence of a modification of the metadata block associated with the further transaction.

5. The method according to claim 4, further comprising:
obtaining the permission based on the transaction identification.

6. The method according to claim 1, wherein the record writing type corresponding to a sub-transaction is pre-configured.

7. The method according to claim 1, wherein the permission is a global lock for performing generation of a metadata modification record in the first storage area.

8. An electronic device for transaction-based metadata maintenance, comprising:
a processor; and
a memory coupled to the processor and having instructions stored thereon, the instructions, when executed by the processor, causing the electronic device to perform acts comprising:
obtaining a transaction that is currently pending, the transaction being associated with a modification of a metadata block, the metadata block containing at least one entry, the transaction comprising at least one sub-transaction, each of which indicates a modification of at least one entry of the metadata block;
ordering the at least one sub-transaction of the transaction depending upon a record writing type of the at least one sub-transaction, the record writing type of the at least one sub-transaction being one of a permission-required control type and a permission-free control type;
in response to acquiring a permission, generating, in a first storage area, a respective metadata modification record preferentially for each sub-transaction of the permission-required control type, wherein the respective metadata modification record describes a modification of at least one entry of the metadata block that is indicated by the sub-transaction; and
in response to generating the metadata modification records for all the sub-transactions of the permission-required control type, releasing the permission such that a further transaction will have an opportunity to acquire the permission.

9. The electronic device according to claim 8, wherein the acts further comprise:
copying the at least one metadata modification records generated in the first storage area into a second storage area, the second storage area being a persistent storage area.

10. The electronic device according to claim 9, wherein the acts further comprise:
allocating the first storage area for the transaction, the first storage area having a mapping relationship with the second storage area.

11. The electronic device according to claim 8, wherein the acts further comprise:
assigning transaction identification for the transaction, the transaction identification indicating a chronological order of occurrence of the modification of the metadata block associated with the transaction and occurrence of a modification of the metadata block associated with the further transaction.

12. The electronic device according to claim 11, wherein the acts further comprise:
obtaining the permission based on the transaction identification.

13. The electronic device according to claim 8, wherein the record writing type corresponding to a sub-transaction is pre-configured.

14. The electronic device according to claim 8, wherein the permission is a global lock for performing generation of a metadata modification records in the first storage area.

15. A computer program product having a non-transitory computer readable medium which stores a set of instructions to perform transaction-based metadata maintenance;
the set of instructions, when carried out by computerized circuitry, causing the computerized circuitry to perform a method of:
obtaining a transaction that is currently pending, the transaction being associated with a modification of a metadata block, the metadata block containing at least one entry, the transaction comprising at least one sub-transaction, each of which indicates a modification of at least one entry of the metadata block;
ordering the at least one sub-transaction of the transaction depending upon a record writing type of the at least one sub-transaction, the record writing type of the at least one sub-transaction being one of a permission-required control type and a permission-free control type;
in response to acquiring a permission, generating, in a first storage area, a respective metadata modification record preferentially for each sub-transaction of the permission-required control type, wherein the respective metadata modification record describes a modification of at least one entry of the metadata block that is indicated by the sub-transaction; and
in response to generating the metadata modification records for all the sub-transactions of the permission-required control type, releasing the permission such that a further transaction will have an opportunity to acquire the permission.
